(19) United States
(12) Patent Application Publication
(10) Pub. No.: US 2010/0326945 A1
(43) Pub. Date: Dec. 30, 2010

(54) SEPARATE TYPE NURSING BOTTLE

(76) Inventor: Je-Woo Yu, Seoul (KR)

Correspondence Address: CANTOR COLBURN LLP, 20 Church Street, 22nd Floor, Hartford, CT, 06103, US

(21) Appl. No.: 12/667,784

(22) PCT Filed: Jul. 4, 2008
(86) PCT No.: PCT/KR08/03974

§ 371 Date: Jan. 5, 2010

(30) Foreign Application Priority Data
Jul. 6, 2007 (KR) 10-2007-0068081

(51) Int. Cl. A61J 9/00

(52) U.S. Cl. 215/11.1

(57) ABSTRACT

Disclosed is a separate type nursing bottle, which includes two separate bodies so as to allow a user to cleanly wash the bodies in a convenient manner. The separate type nursing bottle includes an upper body, a lower body, and a connector. The upper body has a pipe-shape and includes screw parts formed at an outer circumferential surface of one end of the upper body and at an outer circumferential surface spaced a predetermined distance from another end of the upper body, respectively. The lower body has a bowl-shape, has an open side engaged with an outer circumferential periphery of the other end of the upper body, and includes a locking jaw formed along an outer circumferential periphery of one end of the open side. The connector has a pipe-shape, has a locking jaw so as to allow the connector to be assembled with an outer side of the upper body while one end of the connector is locked in the locking jaw of the lower body, and also has a screw part engaged with the screw part of the another end of the upper body. The upper body from the screw part to the other end is slanted toward a central axis of the upper body so that an inner diameter is smaller toward the other end. The lower body is made from material, which is more flexible than material of the upper body, so as to allow a shape of the lower body to be easily changed. As a result, there is a sanitary advantage in that the user can cleanly wash the interior of the nursing bottle, and convenience can be provided to the user while washing the bottle.

### TECHNICAL FIELD

The present invention relates to a separate type nursing bottle, and more particularly to a separate type nursing bottle including two separate bodies so as to allow user to cleanly wash the bodies in a convenient manner.

### BACKGROUND ART

In general, a nursing bottle is used for feeding babies.

Among the accompanying drawings, FIG. 3 illustrates a conventional nursing bottle 10.

As shown in FIG. 3, the nursing bottle 10 includes a main body 11, which has a cylindrical shape having one open side and holds milk or powdered milk in an interior space thereof, a nipple connecter 12 detachably assembled with the main body 11, a nipple 13 having one end, which is received in and is assembled with the nipple connector 12, and a lid 14 for covering the nipple connector 12.

A predetermined screw part 11a is formed at an outer circumferential surface of the open end of the main body 11. A screw part 12a is formed at an inner side of the nipple connector 12 so as to correspond to the screw part 11a of the main body 11. The nipple 13 is made from sanitary rubber, etc. A locking jaw 14a is formed at an inner circumferential surface of one open end of the lid 14.

When a baby is fed by using such a nursing bottle 10, the nipple connector 12 is separated from the main body 11, and a predetermined amount of powdered milk, etc. is poured into the main body 11. Then, warm water is poured into the main body 11, and powdered milk and the warm water are equally mixed with each other.

Then, after feeding, the nipple connector 12 is separated from the main body 11. The nipple connector and the main body are washed and are sterilized/disinfected. Then, they are dried so as to be reused. Remaining liquid, such as milk, etc., is easily dried and attached to the interior of the nursing bottle so that it is very important, for sanitary reasons, to wash the nursing bottle. Therefore, the interior of the main body 11 of the nursing bottle is washed by using a cleaning brush, etc. Then, the nursing bottle is put into water so as to be sterilized/disinfected by heating the water or by using an electric oven.

However, in a case where a conventional nursing bottle is cleaned, there is a problem in that the interior space 11a cannot be cleanly washed because it is difficult for the cleaning brush to reach or make close contact with upper and lower parts of the interior of the main body 11. Also, the open part of the main body 11 is narrow so that it is difficult for the user to wash the interior of the nursing bottle by inserting his/her hands into the interior.

### DISCLOSURE OF INVENTION

### Technical Problem

The present invention has been made in view of the above-mentioned problems, and the present invention provides a separate type nursing bottle including two separate bodies so as to allow a user to cleanly wash the bodies in a convenient manner.

### Technical Solution

In accordance with an aspect of the present invention, there is provided a separate type nursing bottle including: an upper body having screw parts formed at an outer circumferential surface of one end of the upper body and at an outer circumferential surface spaced a predetermined distance from another end of the upper body, respectively, the upper body having a pipe-shape; a lower body, which has an open side engaged with an outer circumferential periphery of the another end of the upper body and has a locking jaw formed along an outer circumferential periphery of one end of the open side, the lower body having a bowl-shape; and a connector having a locking jaw so as to allow the connector to be assembled with an outer side of the upper body while one end of the connector is locked in the locking jaw of the lower body, the connector having a screw part engaged with the screw part of the another end of the upper body, and the connector having a pipe-shape, wherein the upper body from the screw part to the another end is slanted toward a central axis of the upper body so that an inner diameter is smaller toward the another end.

It is preferable that the lower body is made from material, which is more flexible than material of the upper body, so as to allow a shape of the lower body to be easily changed.

### Advantageous Effects

According to the present invention structured as described above, there is a sanitary advantage in that the user can cleanly wash the nursing bottle, and convenience can be provided to the user while washing the bottle.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a partially exploded sectional view of a nursing bottle according to the present invention;

FIG. 2 is a partially exploded sectional view of the nursing bottle shown in FIG. 1; and

FIG. 3 is a sectional view of a conventional nursing bottle.

### MODE FOR THE INVENTION

Hereinafter, an exemplary embodiment of the present invention will be described with reference to the accompanying drawings.

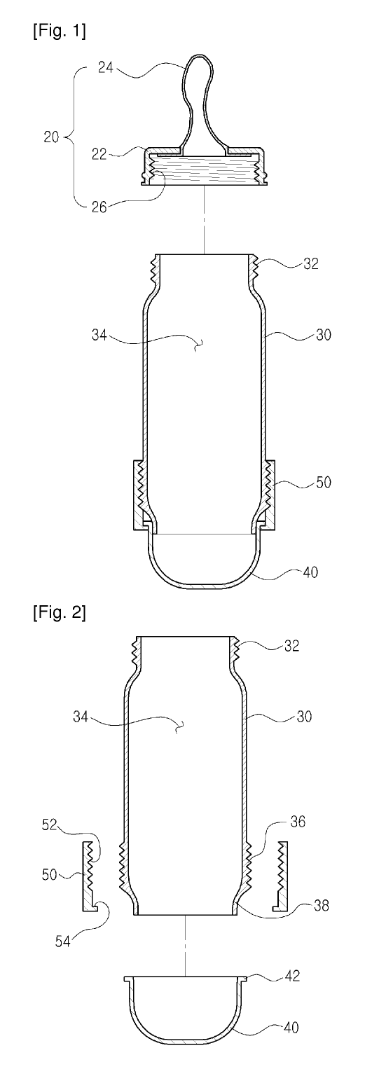

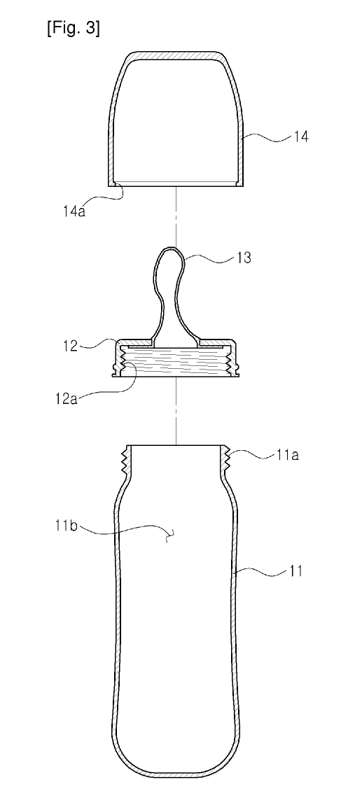

Among the companying drawings, FIGS. 1 and 2 illustrate a nursing bottle according to the present invention.

With reference to FIG. 1, a separate type nursing bottle includes a nipple assembly 20, an upper body 30, a lower body 40, and a connector 50. Also, although not shown, a lid for covering the nipple assembly 20 can be provided.

The nipple assembly 20 is formed in such a manner that a nipple connector 22 is assembled with one end of a nipple 24. A screw part 26 is formed at an inner circumferential surface of the nipple connector 22. The upper body 30 is nearly shaped like a pipe and has screw parts 32 and 36 formed at an outer circumferential surface of the upper end thereof and an outer circumferential surface spaced a predetermined distance from a lower end of the upper body 30, respectively. As shown, the screw part 26 of the nipple connector 22 is assembled with the screw part 32 formed at an upper end of the upper body 30. As shown, the lower end of the upper body 30 is slanted toward the central axis of the upper body. Particularly, a lower part of the screw part 36 of the upper body 30 is slanted toward the interior thereof so that the inner diameter of the upper body 30 is smaller toward the lower end.

The lower body 40 is nearly shaped like a concave bowl, and an open side of the lower body is engaged with an outer circumferential periphery of the lower end of the upper body 30. A locking jaw 42 is formed along an outer circumferential periphery of the open side of the lower body 40. The lower body 40 is made from flexible material so as to allow the shape thereof to be easily changed. Particularly, although the upper body 30 is made from typical material used for a nursing bottle, the lower body 40 is made from material which is more flexible than the material of the upper body 30. If the lower body 40 is made from flexible material, in a case where a small amount of contents remains within the lower body, it is possible for the user to accelerate discharging of contents by pushing on the lower body 40 by his/her fingers.

The connector 50 connects the upper body 30 and the lower body 40 with each other and is nearly shaped like a pipe. Also, the connector 50 is assembled with an outer side of the upper body 30 by screws. Particularly, the screw part 52 is formed at an inner circumferential surface of the connector 50 so as to be engaged with the screw part 36 of the upper body 30. A locking jaw 54 is formed at one end of the connector 50 so as to be locked in the locking jaw 42 of the lower body 40.

The separating and assembling operation of the nursing bottle structured as described above will be described.

Firstly, when the nursing bottle is assembled, the lower end of the upper body 30 is inserted into the inner side of the lower body 40, and the connector 50 is assembled in a direction going from the lower body 40 toward the upper body 30. Then, in a state where the upper body 30 and the lower body 40 are engaged with each other, the screw part 52 of the connector 50 is screw-assembled with the screw part 36 of the upper body 30.

At this time, the locking jaw 54 of the connector 50 is locked into the locking jaw 42 of the lower body 40 so that the upper body 30 and the lower body 40 are assembled with each other while making close contact with each other.

Meanwhile, since the lower part of the upper body 30 is slanted, the user can easily assemble the lower body 40 with the upper body in an initial assembling step. Also, the lower body 40 can make close contact with the upper body to be assembled therewith while the lower body 40 is pushed upward along the slanted surface of the lower end of the upper body 30.

Then, in a case where the nursing bottle is separated, screw-assembling between the upper body 30 and the connector 50 is released, and the lower body 40 is separated from the upper body 30.

Meanwhile, although such a separate type nursing bottle is illustrated as only a nursing bottle in the present embodiment of the present invention, it can be used as a refill bottle for holding an ion drink, etc.

As described above, in the separate type nursing bottle according to the present invention, the bodies are separated from each other. Therefore, the user can easily insert a cleaning brush into the interior of each body so that the nursing bottle can be cleanly washed.

As described above, although several exemplary embodiments of the present invention have been described for illustrative purposes, those skilled in the art will appreciate that various modifications, additions and substitutions are possible, without departing from the scope and spirit of the invention.

1. A separate type nursing bottle comprising:
an upper body 30 having screw parts 32 and 36 which are formed at an outer circumferential surface of one end of the upper body and at an outer circumferential surface spaced a predetermined distance from another end of the upper body, respectively, the upper body having a pipe-shape;
a lower body 40 which has an open side engaged with an outer circumferential periphery of the another end of the upper body 30 and has a locking jaw 42 formed along an outer circumferential periphery of one end of the open side, the lower body having a bowl-shape; and
a connector 50 having a locking jaw 54 so as to allow the connector to be assembled with an outer side of the upper body 30 while one end of the connector 50 is locked in the locking jaw 42 of the lower body 40, the connector 50 having a screw part 52 engaged with the screw part 36 of the another end of the upper body 30, and the connector having a pipe-shape,
wherein the upper body 30 from the screw part 36 to another end is slanted toward a central axis of the upper body so that an inner diameter is smaller toward another end.

2. The separate type nursing bottle as claimed in claim 1, wherein the lower body 40 is made from material which is more flexible than material of the upper body 30, so as to allow a shape of the lower body to be easily changed.
